(19) United States
(12) Patent Application Publication
(10) Pub. No.: US 2005/0237564 A1
(43) Pub. Date: Oct. 27, 2005

(54) Printer, print processing program product, and print processing method

(75) Inventor: Tetsuya Sugimoto, Muko-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 10/909,361

(22) Filed: Aug. 3, 2004

(30) Foreign Application Priority Data
Apr. 23, 2004 (JP) 2004-128623

(51) Int. Cl. G06F 15/16; G06F 9/00; G06F 3/12

(52) U.S. Cl. 358/1.15; 715/740; 709/206

(57) ABSTRACT

A printer includes a first input portion which receives user address information, a URL notification portion which notifies the user address of a URL of a web page in which print setting for data-to-be-printed is to be performed based on the received user address information, a second input portion which receives information of the print setting set on the web page by the user accessed the web page, and a print processing portion which prints the data-to-be-printed at the print setting based on the received information of the print setting.

This application claims priority under 35 U.S.C. § 119 to Japanese Patent Application No. 2004-128623 filed on Apr. 23, 2004, the entire disclosure of which is incorporated herein by reference in its entirety.

### BACKGROUND OF THE INVENTION

1. Field of the Invention

The present invention relates to a printer, a print processing program product and a print processing method capable of printing data-to-be-printed at user's desired print settings.

2. Description of Related Art

The following description sets forth the inventor's knowledge of related art and problems therein and should not be construed as an admission of knowledge in the prior art.

Conventionally, printing of document data, etc. created by a user computer, etc. has been performed as follows. That is, after the completion of print settings by a user using a printer driver, the print setting information is transmitted to a printer with the information embedded in the print job including the document data, then the printer performs the printing in accordance with the print setting information.

In this conventional method, however, a dedicated printer driver is required for performing the printing, and therefore inherent functions of the printer cannot be used in the environment that the printer driver does not exist.

Under the circumstances, Japanese Unexamined Laid-open Patent Publication 2003-46690 proposes a printer capable of making inherent functions of the printer available even in the environment that no dedicated printer driver exists. In this printer, functions (e.g., bookbinding function) are registered at an address of the printer in advance, and printing is performed in accordance with the setting corresponding to the address owned by the printer when the user transmits a job to the address.

In this proposed printer, however, it is required to set an address every print function, and therefore the setting is bothersome and the usability is poor.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a printer capable of not only printing data-to-be-printed in an environment that no dedicated printer driver exists but also printing the data easily at user's desired settings without setting an address every print function.

Among other potential advantages, some embodiments can provide a print processing program product capable of not only printing data-to-be-printed in an environment that no dedicated printer driver exists but also printing the data easily at user's desired settings without setting an address every print function.

Among other potential advantages, some embodiments can provide a print processing method capable of not only printing data-to-be-printed in an environment that no dedicated printer driver exists but also printing the data easily at user's desired settings without setting an address every print function.

According to a first aspect of a preferred embodiment of the present invention, a printer, comprises:
a first input portion which receives user address information;
a URL notification portion which notifies the user address of a URL of a web page in which print setting for data-to-be-printed is to be performed based on the received user address information;
a second input portion which receives information of the print setting set on the web page by the user accessed the web page; and
a print processing portion which prints the data-to-be-printed at the print setting based on the received information of the print setting.

According to a second aspect of a preferred embodiment of the present invention, a print processing program product which makes a computer execute:
a step of receiving user address information;
a step of notifying the user address of a URL of a web page in which print setting for data-to-be-printed is to be performed based on the received user address information;
a step of receiving information of the print setting set on the web page by the user accessed the web page; and
a step of printing the data-to-be-printed at the print setting based on the received information of the print setting.

According to a third aspect of a preferred embodiment of the present invention, a print processing method, comprises:
a step of receiving user address information;
a step of notifying the user address of a URL of a web page in which print setting for data-to-be-printed is to be performed based on the received user address information;
a step of receiving information of the print setting set on the web page by the user accessed the web page; and
a step of printing the data-to-be-printed at the print setting based on the received information of the print setting.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a block diagram of the printer according to an embodiment of the present invention;

FIG. 2 shows a data flow between the printer 1 and the user terminal 2;

FIG. 3 is a flowchart showing the flows of print receipt and the print processing performed by the printer;

FIG. 4 is a flowchart showing the contents of the web page creation and display processing for print setting shown in S5 in FIG. 3;

FIG. 5 is an explanatory view showing a web page;

FIG. 6 is an explanatory view showing another web page;

FIG. 7 is an explanatory view showing still another web page;

FIG. 8 is an explanatory view showing still yet another web page; and

FIG. 9 is an explanatory view showing still yet another web page.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

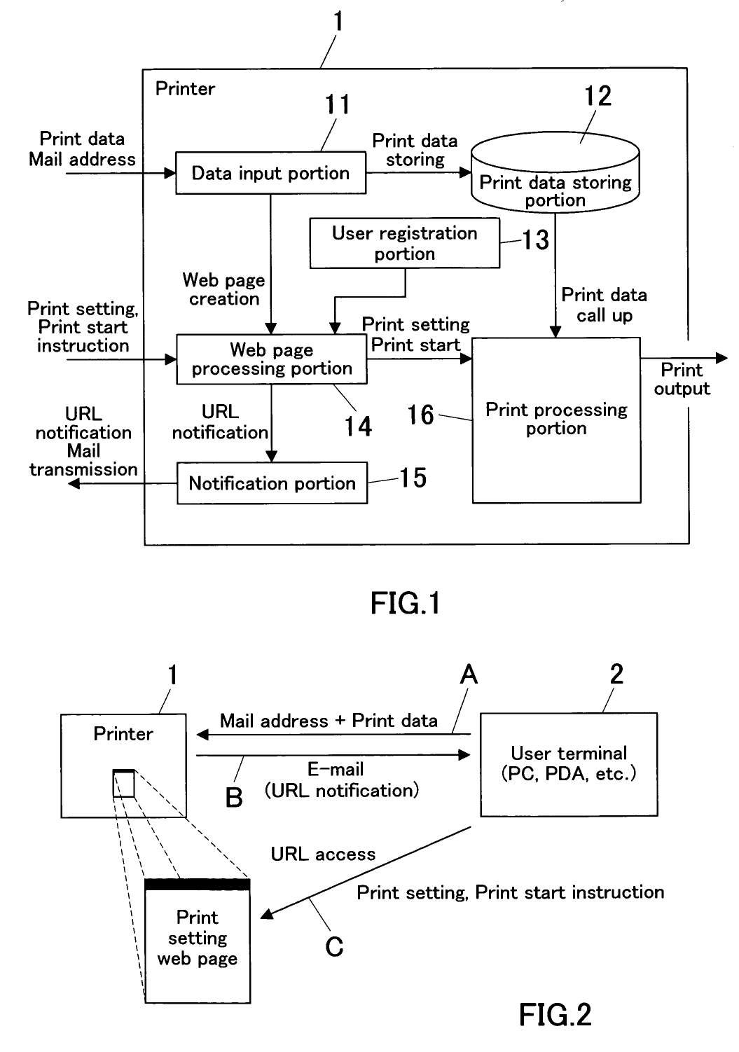

FIG. 1 is a block diagram showing a structure of a printer according to an embodiment of the present invention.

In FIG. 1, the reference numeral “1” denotes a printer. This printer 1 is connected to a user terminal 2 (see FIG. 2) such as a computer (hereinafter may be referred to as “PC”) owned by a user and a Personal Digital Assistance (PDA) via a network.

The printer 1 is provided with a data input portion 11, a print data storing portion 12, a user registration portion 13, a web page processing portion 14, a notification portion 15, and a print processing portion 16.

The data input portion 11 receives a print request including a user name, user address information and data-to-be-printed (hereinafter may simply referred to as “print data”) transmitted from the user using a user terminal 2, and functions as a first input means.

The print data storing portion 12 is a portion for storing the print data received by the data input portion 11 with the print data associated with the mail address which is the user address information.

The user registration portion 13 is a portion for storing unique print settings for a user, i.e., an address of the user who wishes customized print settings and the user's desired print settings, in advance.

The web page processing portion 14 creates a print setting web page for receiving print settings and a print start instruction made by a user and the URL (Uniform Resources Locator) of the web page, and displays the web page when the web page is accessed by the user. This processing portion 14 also functions as a second input means for receiving print setting information and a print start instruction made by the user on the web page, and transmits the received print setting information and the print start instruction to the print processing portion 16. In this embodiment, it is constituted that the contents of the web page to be created by the web page processing portion 14 differ depending on whether the user transmitted the print request is registered in the user registration portion 13.

The notification portion 15 has a function of notifying the address received by the data input portion 11 of the URL of the print setting web page created by the web page processing portion 14 via an emai. This notice also functions as an acknowledgment of print receipt.

The print processing portion 16 calls up the print data stored in the print data storing portion 12 in accordance with the print setting information and the print start instruction transmitted from the web page processing portion 14, and then prints the print data based on the print setting information.

FIG. 2 shows a data flow between the printer 1 and the user terminal 2.

A user transmits a print request, address information of the user and print data from the user terminal 2 to the printer 1 (see arrow A). Then, the printer 1 transmits an email notifying the user of the URL of the web page of the printer (see arrow B).

The user who received the email accesses the URL of the web page from the user terminal 2 to display the web page on the display (not shown) of the user terminal 2, and transmits print settings and a print start instruction set on the web page to the printer 1 (see arrow C). The printer 1 receives the print setting information and the print start instruction and then executes the printing by the print processing portion 16.

In this embodiment, the data exchange between the printer 1 and the user terminal 2 is performed by an email. However, in place of the email, another method such as FTP can be employed.

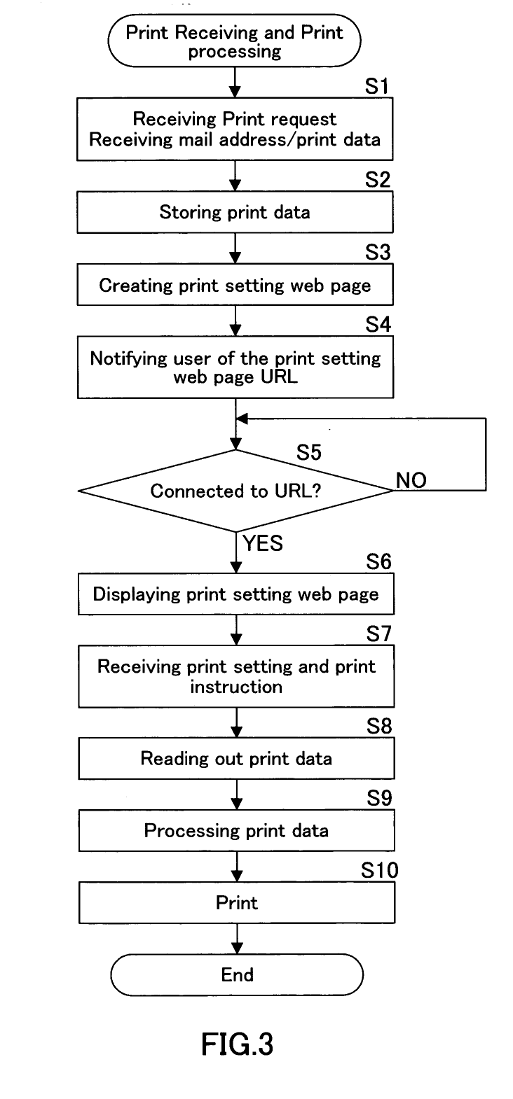

The print receipt and print processing at the printer side 1 until the printing is performed will be explained with reference to the flowchart shown in FIG. 3. In the following explanation and drawings, Step will be abbreviated as “S.”

At S1 of FIG. 3, in the printer 1, the print request, the user address information and the print data sent from the user terminal 2 are received by the data input portion 11. Thereafter, at Step 2, the print data is stored in the print data storing portion 12 with the data associated with the address, and the routine proceeds to S3.

At S3, a web page and the URL thereof are created in the web page processing portion 14. At S4, the web page processing portion 14 transmits the URL to the user terminal 2 via the notification portion 15. Then, the routine proceeds to S5 and waits that the user accesses the web page by connecting to the URL (No at S5). If there is an access to the web page (Yes at S5), at S6, the web page processing portion 14 causes the created web page to be displayed on the user terminal 2.

When the user completes the print settings and the print start instruction on the displayed web page, at S7, the print setting information and the print start instruction are received by the web page processing portion 14 and then transmitted to the print processing portion 16.

At S8, the print processing portion 16 reads out the corresponding print data from the print data storing portion 14 and then executes processing of the print data at S9. Then, at S10, the print processing portion 16 prints the print data in accordance with the print setting information on a paper.

Thus, with this printer 1, a user can print the print data such as PDF documents and an XML documents by the printer 1 without opening application software at the user terminal 2 (direct print). In detail, when a user transmits a print request, the user address information and the print data such as PDF documents and XML documents to the printer 1, the printer 1 stores the print data (PDF or XML documents) and notifies the user of the URL of the web page in which the print settings and the print start instruction are to be performed via an email. When the user who received the URL from the printer 1 performs desired print settings and sends a print start instruction on the specified web page, the print data such as PDF documents and XML documents are printed in accordance with the print setting information specified by the user on the web page.

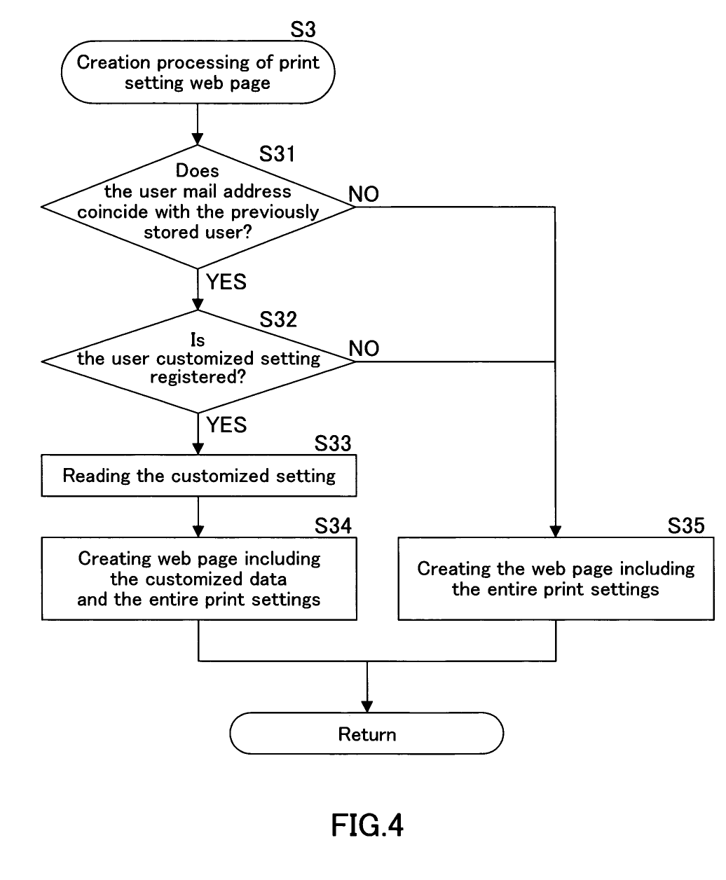

FIG. 4 is a flowchart showing the contents of the web page creation processing for print setting shown as S3 in FIG. 3.

At S31, the web page processing portion 14 discriminates whether the transmitted user address coincides with the user address previously registered in the user registration portion 13.

If the user address does not coincide with the previously registered user address (No at S31), the routine proceeds to S35. Otherwise (Yes at S31), the routine proceeds to S32.

At S32, it is discriminated whether print setting information customized for the user has been registered in the user registration portion 13. If not registered (No at S32), the routine proceeds to S35. If registered (Yes at S32), the routine proceeds to S33.

At S33, the customized print settings registered in the user registration portion 13 are read in, and then a web page including the customized print settings and all of non-customized print settings is created.

On the other hand, at S35, since there is no print setting customized for the user, a web page including all of print settings not customized for the user is created.

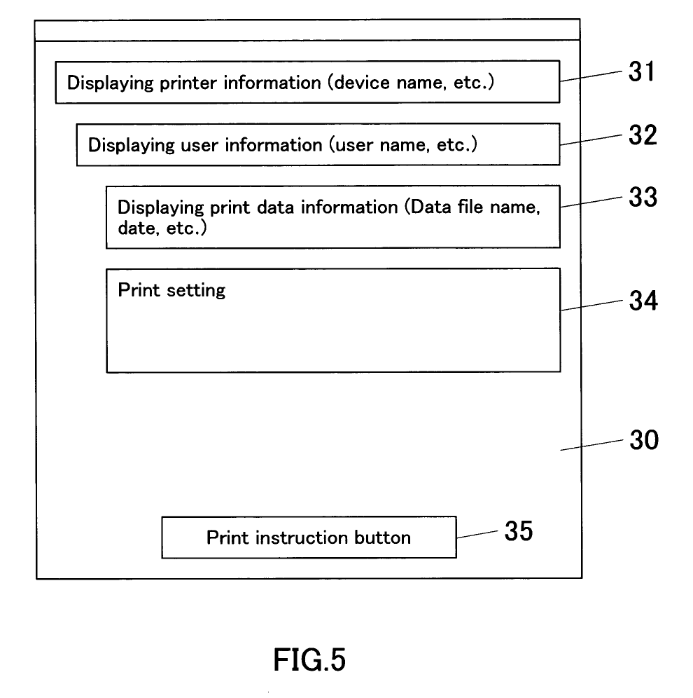

FIGS. 5 to 8 show concrete examples of created web pages.

In the example shown in FIG. 5, the web page 30 displays a printer information display portion 31 showing a device name or the like, a user information display portion 32 showing a user name or the like, a print data information display portion 33 showing a file name or a creation date of print data, a print setting portion 34 and a print instruction button 35.

In the print setting portion 34, all of the print settings capable of being performed by the printer 1 are displayed.

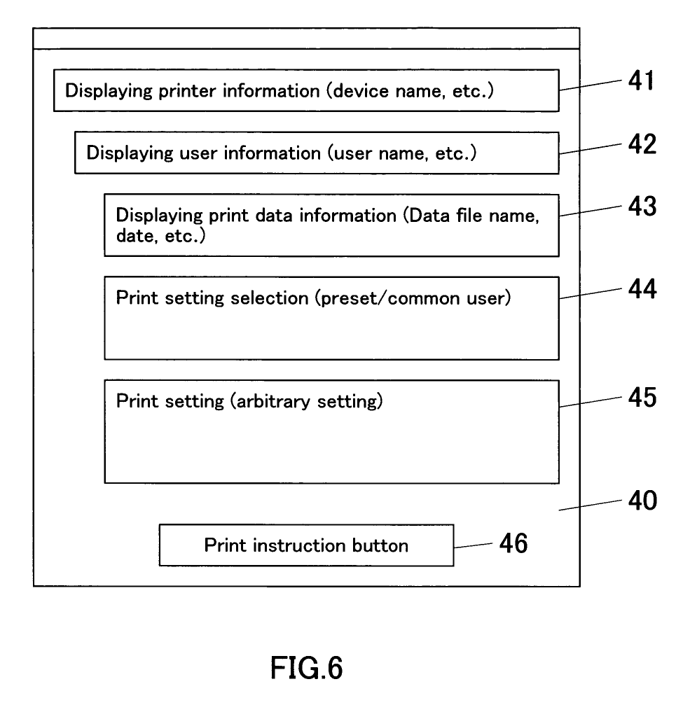

In the example shown in FIG. 6, the web page 40 displays a printer information display portion 41 showing a device name or the like, a user information display portion 42 showing a user name or the like, a print data information display portion 43 showing a file name or a creation date of print data, a print setting selection portion 44, a print setting portion 45, and a print instruction button 46.

In the print setting selection portion 44, frequently used user common settings previously registered at the printer side, e.g., two-side print setting or 2-in-1 print setting for printing two page print data on one page, are displayed.

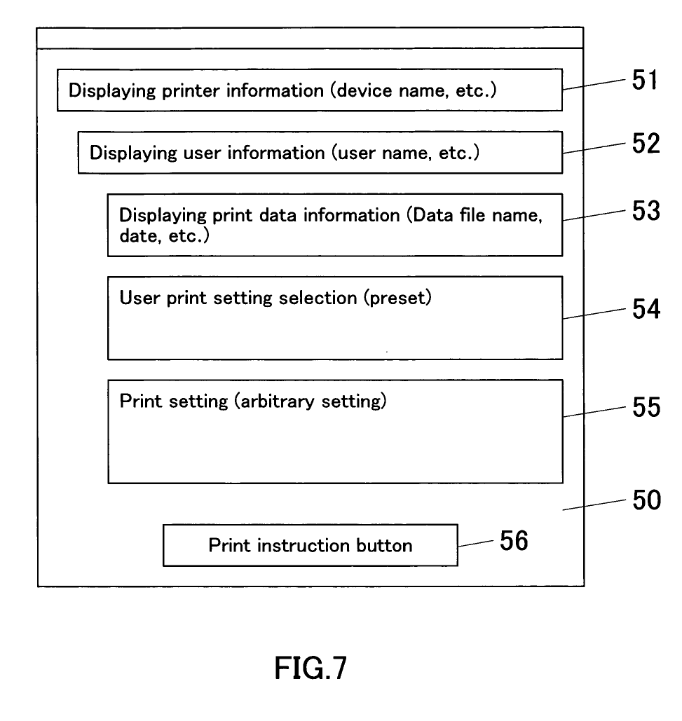

In the example shown in FIG. 7, the web page 50 displays a printer information display portion 51 showing a device name or the like, a user information display portion 52 showing a user name or the like, a print data information display portion 53 showing a file name or a creation date of print data, a user print setting selection portion 54, a print setting portion 55, and a print instruction button 56.

In the user print setting selection portion 54, user customized print settings registered every user in the user registration portion are displayed. Furthermore, in the print setting portion 55, all of the print settings available for the printer 1 are displayed.

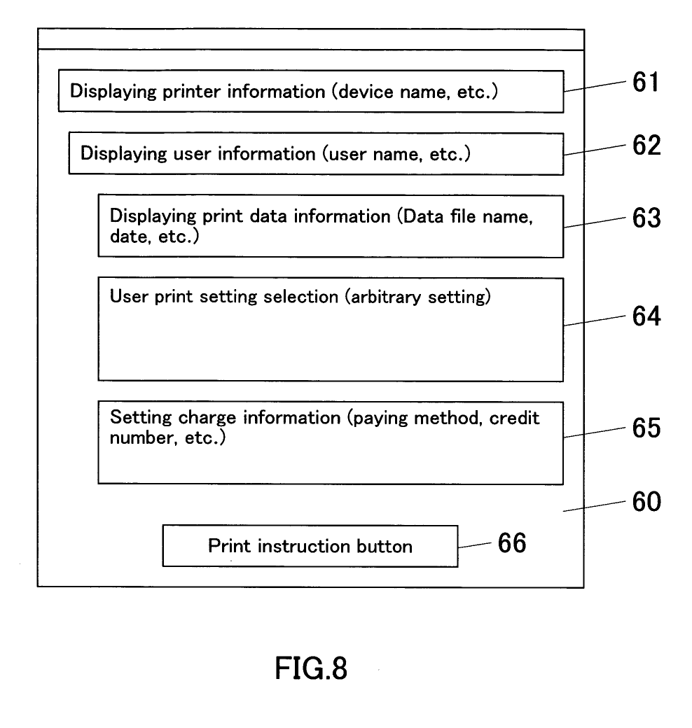

In the example shown in FIG. 8, the web page 60 displays a printer information display portion 61 showing a device name or the like, a user information display portion 62 showing a user name or the like, a print data information display portion 63 showing a file name or a creation date of print data, a print setting selection portion 64, an account information setting portion 65, and a print instruction button 66.

In the print setting portion 64, all of the print settings available for the printer 1 are displayed. Further, in the account information setting portion 65, account information such as a payment method and a credit card number is displayed.

In the aforementioned embodiments, the explanations are directed to the so-called direct printing in which printing is performed by directly transmitting the address and the print data to the printer 1 without opening any application software of the user terminal. However, the followings can also be employed.

[Printing Using a Web Service]

Documents such as estimate sheets created by a web service that a user utilizes are printed by the printer 1 specified by a user. In this web service, a user inputs the IP address of the printer 1 and the user address information to print the web service documents. The printer received the data from the web service stores the print data and notifies the address transmitted together with the print data of the URL of the web page in which the user performs print settings and instructs the print start. The user received the notice from the printer accesses the specified URL to perform his/her desired print settings and issues a print start instruction. The printer starts the printing in accordance with the print setting information specified by the user on the web page.

In a web service, it is difficult to execute processing corresponding to the abilities of a printer (it is required to obtain the abilities from the device, display the settings corresponding to the abilities and have the user specify). However, when the setting corresponding to the device abilities is performed at the printer, in the web service, the settings regarding the printing can be separated, resulting in a simple design system, which in turn enables various printers to be applied.

[Printing Using Application Software which Outputs PDL]

In the case of using application software which outputs printer description language (PDL) capable of being processed by a printer, sending the user address together with the print data enables the printing with the print setting corresponding to the device abilities without using a printer driver of the user terminal.

[Printing Using a Printer Driver]

While using a printer driver, printing using a basic function is performed via the printer driver, and settings depending on the printer is performed on the web page. In this case, since the printer driver can be a driver only having basic functions, the printer driver can be a driver commonly used for a plurality of printers.

Although the above explanations are directed to preferred embodiments of the present invention, the present invention is not limited to these embodiments. For example, in the above explained embodiment, the print data is transmitted to the printer together with the user address. In place of this embodiment, it can be constituted that the print data is previously stored in the print data storing portion or another server and then the print data is specified on the web page among the stored data.

Furthermore, it can be constituted that a user can specify the print start time on a web page.

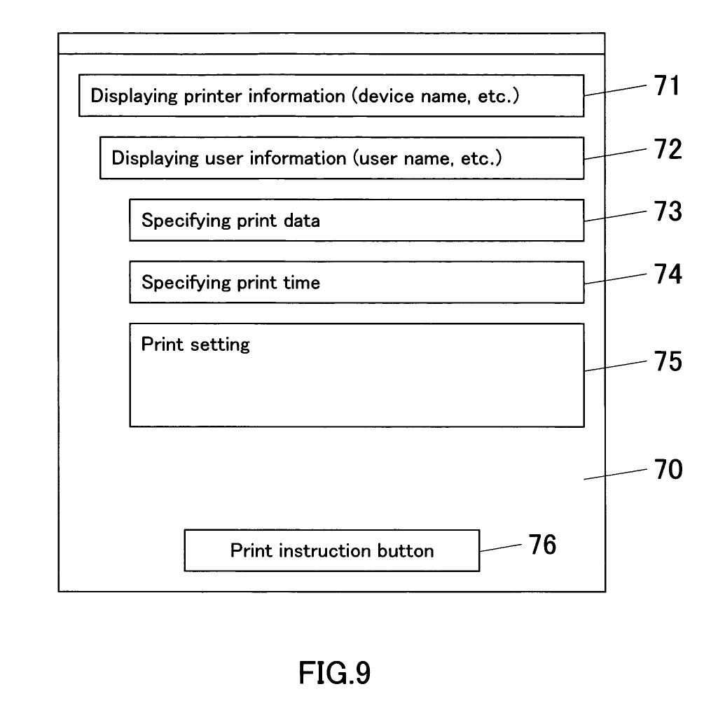

FIG. 9 shows a web page 70 in which the print data and the print start time can be specified. This web page 70 displays a print data specifying portion 73 and the print time specifying portion 74. In FIG. 9, the reference numeral 71 denotes a printer information display portion, 72 a user information display portion, 75 a print setting portion and 76 a print instruction button, which are the same those as shown in FIG. 5.

The print receiving and the print processing shown in FIG. 2 and performed by the printer 1 can be performed by executing print processing program recorded in storing medium such as a ROM, a hard disk, a CD-ROM and an optical magnetic disk by a computer.

The printing processing program can be provided as a storing medium in which the program is recorded, or a network communication, or a program product.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

1. A printer, comprising:
a first input portion which receives user address information;
a URL notification portion which notifies the user address of a URL of a web page in which print setting for data-to-be-printed is to be performed based on the received user address information;
a second input portion which receives information of the print setting set on the web page by the user accessed the web page; and
a print processing portion which prints the data-to-be-printed at the print setting based on the received information of the print setting.

2. The printer as recited in claim 1, wherein the first input portion receives the data-to-be-printed together with the user address information.

3. The printer as recited in claim 1, wherein the information of the print setting includes designation of the data-to-be-printed stored in a storing device.

4. A print processing program product which makes a computer execute:
a step of receiving user address information;
a step of notifying the user address of a URL of a web page in which print setting for data-to-be-printed is to be performed based on the received user address information;
a step of receiving information of the print setting set on the web page by the user accessed the web page; and
a step of printing the data-to-be-printed at the print setting based on the received information of the print setting.

5. The print processing program product as recited in claim 4, wherein in the step of receiving user address information the data-to-be-printed is received together with the user address information.

6. The print processing program product as recited in claim 4, wherein the information of the print setting includes designation of the data-to-be-printed stored in a storing device.

7. A print processing method, comprising:
a step of receiving user address information;
a step of notifying the user address of a URL of a web page in which print setting for data-to-be-printed is to be performed based on the received user address information;
a step of receiving information of the print setting set on the web page by the user accessed the web page; and
a step of printing the data-to-be-printed at the print setting based on the received information of the print setting.

8. The print processing method as recited in claim 7, wherein in the step of receiving user address information the data-to-be-printed is received together with the user address information.

9. The print processing method as recited in claim 7, wherein the information of the print setting includes designation of the data-to-be-printed stored in a storing device.
